(19) United States
(12) Patent Application Publication
(10) Pub. No.: US 2024/0180247 A1
(43) Pub. Date: Jun. 6, 2024

(54) VAPOR GENERATION DEVICE AND RESISTANCE HEATER FOR VAPOR GENERATION DEVICE

(71) Applicant: SHENZHEN FIRST UNION TECHNOLOGY CO., LTD., Shenzhen City, Guangdong Province (CN)

(72) Inventors: JIAN WU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/285,020

(22) PCT Filed: Mar. 18, 2022
(86) PCT No.: PCT/CN2022/081694

§ 371 Date: Sep. 29, 2023

(30) Foreign Application Priority Data
Mar. 29, 2021 (CN) 202120637200.3

(51) Int. Cl. A24F 40/46; A24F 40/20; A24F 40/485; H05B 3/40

(52) U.S. Cl. CPC A24F 40/46; A24F 40/20; A24F 40/485; H05B 3/40

(57) ABSTRACT

This application provides a vapor generation device and a resistance heater for a vapor generation device. The vapor generation device includes a housing, where the housing is provided with: a chamber, extending between a proximal end and a distal end opposite to each other and configured to removably receive the aerosol generation product; a heating element, configured to heat the aerosol generation product received in the chamber; a keeping element, constructed to extend in an axial direction of the chamber and at least partially surround the chamber, where the keeping element defines a hollow region at least partially surrounding the chamber, and the heating element is kept in the hollow region; and an air channel, extending at least partially from the proximal end toward the distal end within the hollow region and keeping fluid communication with the chamber at a position close to the distal end.

### CROSS-REFERENCE TO RELATED APPLICATIONS

This application claims priority to Chinese Patent Application No. 202120637200.3, filed with China National Intellectual Property Administration on Mar. 29, 2021 and entitled “VAPOR GENERATION DEVICE AND RESISTANCE HEATER FOR VAPOR GENERATION DEVICE”, which is incorporated herein by reference in its entirety.

### TECHNICAL FIELD

Embodiments of this application relate to the technical field of heat-not-burn cigarette devices, and in particular, to a vapor generation device and a resistance heater for a vapor generation device.

### BACKGROUND

Tobacco products (such as cigarettes, cigars, and the like) burn tobacco during use to produce tobacco smoke. Attempts are made to replace these tobacco-burning products by manufacturing products that release compounds without burning tobacco.

An example of this type of products is a heating device that releases the compounds by heating rather than burning materials. For example, the materials may be tobacco or another non-tobacco product, where the non-tobacco products may or may not include nicotine. As another example, there is a heating device that heats a tobacco product through a heater to release a compound to form an aerosol. For example, as a known technology, Patent No. 201280070578.3 provides a design suitable for an airflow path in an inhalation process of the heating device. When the foregoing known device is in use, heat of the heater is radially radiated or transferred outwardly to an outer housing of the device, thereby increasing the temperature of the outer housing.

### SUMMARY

An embodiment of this application provides a vapor generation device, configured to heat an aerosol generation product to generate an aerosol, and including a housing, where the housing has a proximal end and a distal end opposite to each other in a length direction; a proximal end is arranged on the receiving hole; and the housing is internally provided with:
a chamber, extending between a proximal end and a distal end opposite to each other and configured to removably receive the aerosol generation product;
a heating element, configured to heat the aerosol generation product received in the chamber;
a keeping element, constructed to extend in an axial direction of the chamber and at least partially surround the chamber, where the keeping element defines a hollow region at least partially surrounding the chamber, and the heating element is kept in the hollow region; and
an air channel, extending at least partially along the proximal end toward the distal end within the hollow region and keeping fluid communication with the chamber at a position close to the distal end.

In a preferred implementation, the keeping element includes an inner tube and an outer tube arranged in sequence from inside to outside in a radial direction, and the hollow region is formed between the inner tube and the outer tube.

In a preferred implementation, an air inlet hole close to the proximal end is provided on the outer tube or the inner tube or between the outer tube and the inner tube, and is configured for allowing air to enter the hollow region.

In a preferred implementation, an air outlet hole close to the distal end is provided on the inner tube, and is configured for allowing air in the hollow region to enter the chamber.

In a preferred implementation, the outer tube has a portion with a reduced outer diameter close to the distal end, and is connected to the inner tube through the part with the reduced outer diameter.

In a preferred implementation, the hollow region has an opening close to the proximal end; and
the housing is further internally provided with a circuit board, and the heating element includes a conductive pin passing through the opening and electrically connected to the circuit board.

In a preferred implementation, the housing is further internally provided with:
a first support, configured to provide support for the keeping element at a position close to the proximal end, and seal the opening.

In a preferred implementation, the housing is further internally provided with:
a second support, configured to provide support for the keeping element at a position close to the distal end, where the second support has a boss extending to the chamber at least partially from the distal end towards the proximal end, to provide a stop for the aerosol generation product received in the chamber; and
the boss covers or spans the air outlet hole along at least part of an extending length along the distal end toward the proximal end.

In a preferred implementation, the heating element is constructed to be tubular or helical around the inner tube.

Another embodiment of this application further provides a resistance heater for a vapor generation device, constructed to be elongated and having a first end and a second end opposite to each other in a length direction, and including:
a keeping element, having an inner tube and an outer tube arranged in sequence from inside to outside in a radial direction, and a hollow region formed between the inner tube and the outer tube, where
a first air hole and a second air hole that are in airflow communication with the hollow region are provided on the inner tube; and the first air hole is arranged close to the first end, the second air hole is arranged close to the second end, and
a resistance heating element, kept in the hollow region.

The vapor generation device has two heat exchange manners of conduction and convection, so that heat of the heating element is substantially completely absorbed by the aerosol generation product, thereby improving the heat utilization rate.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of a use state of a vapor generation device according to an embodiment.

FIG. 2 is a schematic cross-sectional view of the vapor generation device in FIG. 1 in a width direction.

FIG. 3 is a schematic cross-sectional view of a heater in FIG. 2.

FIG. 4 is a schematic structural diagram of a keeping element in FIG. 3 from a perspective.

FIG. 5 is a schematic structural diagram of a heating element in FIG. 3 from a perspective.

FIG. 6 is a schematic cross-sectional view of a heating element according to another embodiment.

### DETAILED DESCRIPTION

For ease of understanding of this application, this application is described below in more detail with reference to the accompanying drawings and specific implementations.

An embodiment of this application provides a vapor generation device that heats but not burns an aerosol generation product, such as a cigarette, so as to volatilize or release at least one component of the aerosol generation product to form an aerosol for inhalation.

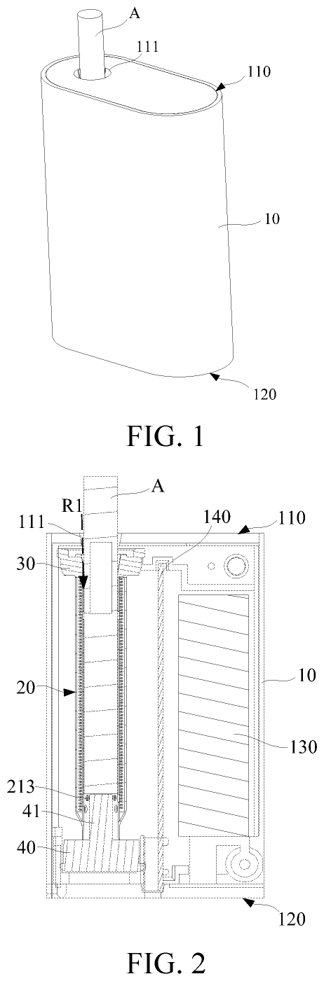

A configuration of the vapor generation device according to an embodiment of this application may be shown in FIG. 1 and FIG. 2. The overall shape of the device is generally constructed to a flat cylinder shape, and an external member of the vapor generation device includes:
a housing 10, having a hollow structure inside, so as to form an assembling space for necessary functional components such as infrared radiation. The housing 10 has a proximal end 110 and a distal end 120 opposite to each other in a length direction, where
the proximal end 110 is provided with a receiving hole 111, and an aerosol generation product A may be received in the housing 10 through the receiving hole 111 and heated or removed from the housing 10; and
the distal end 120 is provided with a charging interface, such as a USB type-C interface or a pin interface, and is configured to charge the vapor generation device after being connected to an external power source or an adapter.

Further, the internal configuration of the housing 10 is shown in FIG. 2, including:
a resistance heater 20, having a tubular shape in a preferred embodiment shown in FIG. 2, and being further configured to surround at least a part of the aerosol generation product A when the aerosol generation product A is received in the housing 10, so as to cause the aerosol generation product A to generate an aerosol by heating an outer periphery of the aerosol generation product A;
a core 130, configured to supply power;
a circuit board 140, configured to guide a current between the core 130 and the resistance heater 20;
an upper support 30, configured to provide support for the resistance heater 20 at a position of the proximal end 110; and
a lower support 40, configured to provide support for the resistance heater 20 at a position of the distal end 120.

In an optional implementation, the resistance heater 20 has a length of about 60 mm to 95 mm and an inner diameter of about 4 mm to 8 mm.

Further, in an optional implementation, the aerosol generation product A is preferably made of a tobacco-containing material that releases a volatile compound from a substrate when being heated, or a non-tobacco material suitable for electric heating and smoking after being heated. The aerosol generation product A is preferably made of a solid substrate. The solid substrate may include one or more of powders, particles, fragmented strips, strips, or flakes of one or more of vanilla leaves, tobacco leaves, homogeneous tobacco, and expanded tobacco. Alternatively, the solid substrate may include additional tobacco or non-tobacco volatile aroma compounds to be released when the substrate is heated.

Further, according to FIG. 2, the lower support 40 has a boss 41 that at least partially protrudes into or extends into the resistance heater 20, which abuts against the boss 41 when the aerosol generation product A is at least partially surrounded or accommodated in the resistance heater 20.

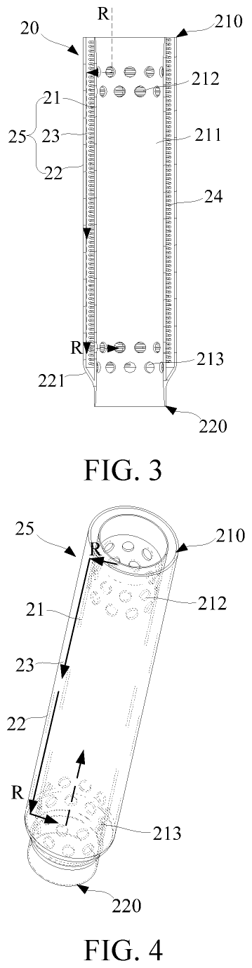

A specific configuration of the resistance heater 20 may be shown in FIG. 3, including:
a heating element 24, electrically connected to the circuit board 140 to generate heat under the power supply of the core 130;
a keeping element 25, constructed to be tubular and having an inner tube 21 and an outer tube 22 arranged in sequence from inside to outside in a radial direction, and a hollow region 23 located between the inner tube 21 and the outer tube 22, where the keeping element 25 is configured to accommodate and keep the heating element 24, and the heating element 24 is accommodated and kept within the hollow region 23 after assembly.

In an optional implementation, the inner tube 21 and the outer tube 22 are made of a heat-resistant and heat-conductive material such as glass, ceramic, metal, or alloy, for example, stainless steel. Certainly, after assembly, the inner tube 21 of the keeping element 25 and the heating element 24 abut against each other to conduct heat to each other, and are insulated from each other. For example, insulation may be formed between contact surfaces by gluing, surface oxidation, or spraying an insulation layer.

The heating element 24 is made of a metal material with an appropriate impedance, a metal alloy, graphite, carbon, conductive ceramic, or another composite material of a ceramic material and a metal material. A suitable metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-chromium-aluminum alloy, titanium alloy, iron-manganese-aluminum based alloy, or stainless steel.

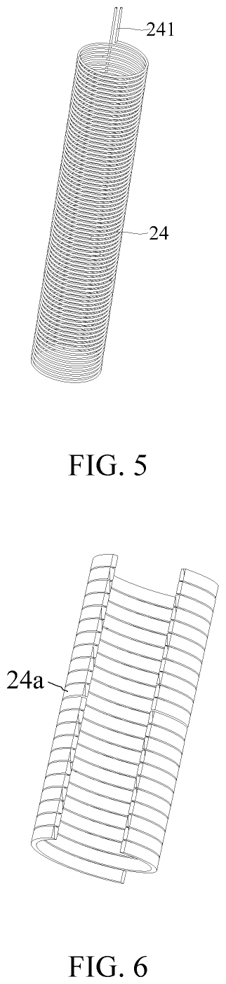

FIG. 5 shows the configuration of the heating element 24 in FIG. 2, which is constructed in a form of a helical coil. The heating element 24 is further provided with a conductive pin 241 connected to the circuit board 140, and the heating element 24 is powered by the conductive pins 241.

In another optional implementation, the heating element 24 may alternatively be prepared by winding a sheet-type mesh resistive substrate. Alternatively, in some other optional implementations, the heating element 24 may alternatively be in a form of a conductive trace formed on the inner tube 21 by printing, deposition, etching, and the like. In another optional implementation, the heating element 24 may be an induction heating element configured to be heated by induction of a magnetic field, and the induction heating element may be positioned in the hollow region 23 or kept on a surface of the inner tube or the outer tube close to the hollow region 23. It may be understood that the heating element 24 may be formed by at least a part of the configuration of the keeping element. For example, at least a part of the inner tube is constructed to induce heat by the magnetic field, thereby radially conducting heat to the aerosol generation product within the chamber while heating the airflow within the hollow region 23.

FIG. 6 shows a schematic structural diagram of a heating element 24 according to another embodiment. The heating element 24a is a spiral coil structure, and a cross section of the wire material thereof is in a wide or flat shape that is different from a conventional circular shape. In a preferred implementation shown in FIG. 6, the cross section of the wire material of the heating element 24a has a size extending in a longitudinal direction that is greater than a size extending in a radial direction perpendicular to a part extending in the longitudinal direction, so that the heating element 24a has a flat rectangular shape.

Further, referring to FIG. 3 and FIG. 4, the hollow of the inner tube 21 of the keeping element 25 forms the chamber 211 for receiving the aerosol generation product A, and the aerosol generation product A is removably received in the chamber 211 through the receiving hole 111.

According to the preferred embodiments shown in FIG. 3 and FIG. 4, the keeping element 25 has an upper end 210 and a lower end 220 opposite to each other. An end of the outer tube 22 close to the lower end 220 is bonded to the inner tube 21 by welding or the like; and an end of the upper end 210 close to the outer tube 22 is not in contact with the inner tube 21, so that the hollow region 23 is in a shape of an opening at the upper end 210, and is blocked or sealed by the upper support 30 of a flexible material after assembly. In a specific implementation, the hollow region 23 is the opening at the upper end 210. On the one hand, the heating element 24 is facilitated to be assemble to the hollow region 23, and on the other hand, the conductive pin 241 for the heating element 24 extends from the opening of the hollow region 23 to the outside and are electrically connected to the circuit board 140.

Specifically, referring to the preferred implementation shown in FIG. 3, the outer tube 22 has a part with a portion 221 with a reduced outer diameter close to the lower end 220. The portion 221 with a reduced outer diameter is gradually contracted, and is connected to the inner tube 21 by the portion 221 with a reduced outer diameter.

More preferably, the inner tube 21 is provided with a plurality of air inlet holes 212 of the upper end 210 and a plurality of air outlet holes 213 close to the lower end 220. After assembly, the air is caused to enter the aerosol generation product A through an air flow path shown by the arrow R in FIG. 3 during the inhalation process. Specifically, the air enters the hollow region 23 from the air inlet hole 212, and then substantially passes through the hollow region 23 toward the lower end 220 in the longitudinal direction and then flows out from the air outlet hole 213, and finally enters the aerosol generation product A and is inhaled. In another variable implementation, the air inlet hole 212 may alternatively be formed on the outer tube 22, or formed by an opening end between the inner tube 21 and the outer tube 22.

The resistance heater 20 has two heat exchange manners of conduction and convection, so that heat of the heating element 24 is substantially completely absorbed by the aerosol generation product A, thereby improving the heat utilization rate. Further, a maximum temperature of the heating element 24 can be reduced, energy consumption can be saved, and a preheating time can be reduced; and a better inhalation taste can be obtained, and more inhalations can be obtained.

Further, as shown in FIG. 2, an outer diameter of the boss 41 of the lower support 40 is substantially less than an inner diameter of the inner tube 21, and the outer diameter of the boss 41 in the specific implementation adopts a size of about 4 mm to design; and the boss 41 of the lower support 40 has a sufficient or proper extension length, so that the boss can cover or span the air outlet hole 213, the air outlet hole 213 is in an exposed state in FIG. 2, and the boss 41 or the aerosol generation product A is prevented from blocking the air outlet hole 213.

Further, in an optional implementation, the outside air entering the air inlet hole 212 may be entered by a gap between the receiving hole 111, the upper support 30, and the aerosol generation product A in FIG. 2. Alternatively, in another variant implementation, the outside air entering the air inlet hole may alternatively be constructed to enter by a structure such as a pore on a side wall and the like of the housing 10.

Further, in a more preferred implementation, some annular protrusions, or sealing materials or sealing structures such as flexible silicone rings (not shown in the figure) can also be added to the inner wall of the inner tube 21, which can be arranged at positions between the air inlet holes 212 and the air outlet holes 213, preferably close to the air inlet hole 212. The sealing material or the sealing structure prevents air from directly entering the gap between the inner tube 21 and the outer surface of the aerosol generation product A directly downward to the end of the aerosol generation product A close to the lower end 220 to be inhaled, so that air can only enter through the hollow region 23 in FIG. 3 to the end of the aerosol generation product A close to the lower end 220.

It should be noted that, the specification and the accompanying drawings of this application provide preferred embodiments of this application, but is not limited to the embodiments described in this specification. Further, a person of ordinary skill in the art may make improvements or modifications according to the foregoing descriptions, and all the improvements and modifications shall fall within the protection scope of the appended claims of this application.

1. A vapor generation device, configured to heat an aerosol generation product to generate an aerosol, and comprising a housing, wherein the housing is internally provided with:
a chamber, extending between a proximal end and a distal end opposite to each other and configured to removably receive the aerosol generation product;
a heating element, configured to heat the aerosol generation product received in the chamber;
a keeping element, constructed to extend in an axial direction of the chamber and at least partially surround the chamber, wherein the keeping element defines a hollow region at least partially surrounding the chamber, and the heating element is kept in the hollow region; and
an air channel, extending at least partially along the proximal end toward the distal end within the hollow region and keeping fluid communication with the chamber at a position close to the distal end.

2. The vapor generation device according to claim 1, wherein the keeping element comprises an inner tube and an outer tube arranged in sequence from inside to outside in a radial direction, and the hollow region is formed between the inner tube and the outer tube.

3. The vapor generation device according to claim 2, wherein an air inlet hole close to the proximal end is provided on the outer tube or the inner tube or between the outer tube and the inner tube, and is configured for allowing air to enter the hollow region.

4. The vapor generation device according to claim 2, wherein an air outlet hole close to the distal end is provided on the inner tube, and is configured for allowing air in the hollow region to enter the chamber.

5. The vapor generation device according to claim 2, wherein the outer tube has a portion with a reduced outer diameter close to the distal end, and is connected to the inner tube through the part with the reduced outer diameter.

6. The vapor generation device according to claim 1, wherein the hollow region has an opening close to the proximal end; and
the housing is further internally provided with a circuit board, and the heating element comprises a conductive pin passing through the opening and electrically connected to the circuit board.

7. The vapor generation device according to claim 6, wherein the housing is further internally provided with:
a first support, configured to provide support for the keeping element at a position close to the proximal end, and seal the opening.

8. The vapor generation device according to claim 4, wherein the housing is further internally provided with:
a second support, configured to provide support for the keeping element at a position close to the distal end, wherein the second support has a boss extending to the chamber at least partially from the distal end towards the proximal end, to provide a stop for the aerosol generation product received in the chamber; and
the boss covers or spans the air outlet hole along at least part of an extending length along the distal end toward the proximal end.

9. The vapor generation device according to claim 2, wherein the heating element is constructed to be tubular or helical around the inner tube.

10. A resistance heater for a vapor generation device, constructed to be elongated and having a first end and a second end opposite to each other in a length direction, and comprising:
a keeping element, having an inner tube and an outer tube arranged in sequence from inside to outside in a radial direction, and a hollow region formed between the inner tube and the outer tube, wherein the inner tube defines a chamber configured to receive an aerosol generation product, and the hollow region at least partially surrounds the chamber;
a first air hole and a second air hole that are in airflow communication with the hollow region are provided on the keeping element, the first air hole is arranged close to the first end, the second air hole is arranged close to the second end, and the hollow region is in fluid communication with the chamber through the second air hole; and
a resistance heating element, kept in the hollow region.

11. The vapor generation device according to claim 3, wherein an air outlet hole close to the distal end is provided on the inner tube, and is configured for allowing air in the hollow region to enter the chamber.

12. The vapor generation device according to claim 11, wherein the housing is further internally provided with:
a second support, configured to provide support for the keeping element at a position close to the distal end, wherein the second support has a boss extending to the chamber at least partially from the distal end towards the proximal end, to provide a stop for the aerosol generation product received in the chamber; and
the boss covers or spans the air outlet hole along at least part of an extending length along the distal end toward the proximal end.

13. The vapor generation device according to claim 3, wherein the outer tube has a portion with a reduced outer diameter close to the distal end, and is connected to the inner tube through the part with the reduced outer diameter.

14. The vapor generation device according to claim 3, wherein the heating element is constructed to be tubular or helical around the inner tube.

15. The vapor generation device according to claim 2, wherein the hollow region has an opening close to the proximal end; and
the housing is further internally provided with a circuit board, and the heating element comprises a conductive pin passing through the opening and electrically connected to the circuit board.

16. The vapor generation device according to claim 15, wherein the housing is further internally provided with:
a first support, configured to provide support for the keeping element at a position close to the proximal end, and seal the opening.

17. The vapor generation device according to claim 3, wherein the hollow region has an opening close to the proximal end; and
the housing is further internally provided with a circuit board, and the heating element comprises a conductive pin passing through the opening and electrically connected to the circuit board.

18. The vapor generation device according to claim 17, wherein the housing is further internally provided with:
a first support, configured to provide support for the keeping element at a position close to the proximal end, and seal the opening.
